(19) United States
(12) Patent Application Publication
(10) Pub. No.: US 2012/0284317 A1
(43) Pub. Date: Nov. 8, 2012

(54) Scalable Distributed Metadata File System using Key-Value Stores

(76) Inventor: Michael W. Dalton, San Francisco, CA (US)

(21) Appl. No.: 13/455,891

(22) Filed: Apr. 25, 2012

Related U.S. Application Data
(60) Provisional application No. 61/517,796, filed on Apr. 26, 2011.

(51) Int. Cl. G06F 17/30

(52) U.S. Cl. 707/827; 707/E17.01

(57) ABSTRACT

A computer-implemented method and a distributed file system in a distributed data network in which file metadata related to data files is distributed. A unique and non-reusable mode number is assigned to each data file that belongs to the data files and a directory of that data file. A key-value store built up in rows is created for the distributed file metadata. Each of the rows has a composite row key and a row value (key-value pair) where the composite row key for each data file includes the mode number and a name of the data file. When present in the directory, the data file is treated differently depending on size. For data files below the maximum file size the entire file or portion thereof is encoded in the corresponding row value of the key-value pair. Data files above maximum file size are stored in large-scale storage.

### RELATED APPLICATIONS

This application claims priority from U.S. Provisional Patent Application 61/517,796 filed on Apr. 26, 2011 and incorporated herein in its entirety.

### FIELD OF THE INVENTION

This invention relates generally to metadata that is related to data files in distributed data networks, and more specifically to a distributed metadata file system that supports high-performance and high-scalability file storage in such distributed data networks.

### BACKGROUND ART

The exponential growth of Internet connectivity and data storage needs has led to an increased demand for scalable, fault tolerant distributed filesystems for processing and storing large-scale data sets. Large data sets may be tens of terabytes to petabytes in size. Such data sets are far too large to store on a single computer.

Distributed filesystems are designed to solve this issue by storing a filesystem partitioned and replicated on a cluster of multiple servers. By partitioning large scale data sets across tens to thousands of servers, distributed filesystems are able to accommodate large-scale filesystem workloads.

Many existing petabyte-scale distributed filesystems rely on a single-master design, as described, e.g., by Sanjay Ghemawat, H. G.-T., “The Google Filesystem”, 19th ACM Symposium on Operating System Principles, Lake George, N.Y. 2003. In that case, one master machine stores and processes all filesystem metadata operations, while a large number of slave machines store and process all data operations. File metadata consists of all of the data describing the file itself. Metadata thus typically includes information such as the file owner, contents, last modified time, unique file number or other identifiers, data storage locations, and so forth.

The single-master design has fundamental scalability, performance and fault tolerance limitations. The master must store all file metadata. This limits the storage capacity of the filesystem as all metadata must fit on a single machine. Furthermore, the master must process all filesystem operations, such as file creation, deletion, and rename. As a consequence, unlike data operations, these operations are not scalable because they must be processed by a single server. On the other hand, data operations are scalable, since they can be spread across the tens to thousand of slave servers that process and store data. Also noted, that metadata for a filesystem with billions of files can easily reach terabytes in size, and such workloads cannot be efficiently addressed with a single-master distributed filesystem.

The trend of increasingly large data sets and an emphasis on real-time, low-latency responses and continuous availability has also reshaped the high-scalability database field. Distributed key-value store databases have been developed to provide fast, scalable database operations over a large cluster of servers. In a key-value store, each row has a unique key, which is mapped to one or more values. Clients create, update, or delete rows identified by their respective key. Single-row operations are atomic.

Highly scalable distributed key-value stores such as Amazon Dynamo described, e.g., by DeCandia, G. H., “Dynamo: Amazon's Highly-Available Key-Value Store”, 2007, SIGOPS Operating Systems Review, and Google BigTable described, e.g., by Chang, F. D., “Bigtable: A Distributed Storage System for Structured Data”, 2008, ACM Transactions on Computer Systems, have been used to store and analyze petabyte-scale datasets. These distributed key-value stores provide a number of highly desirable qualities, such as automatically partitioning key ranges across multiple servers, automatically replicating keys for fault tolerance, and providing fast key lookups. The distributed key-value stores support billions of rows and petabytes of data.

What is needed is a system and method for storing distributed filesystem metadata on a distributed key-value store, allowing for far more scalable, fault-tolerant, and high-performance distributed filesystems with distributed metadata. The challenge is to provide traditional filesystem guarantees of atomicity and consistency even when metadata may be distributed across multiple servers, using only the operations exposed by real-world distributed key-value stores.

### OBJECTS AND ADVANTAGES OF THE INVENTION

In view of the shortcomings of the prior art, it is an object of the invention to provide a method for deploying distributed file metadata in distributed file systems on distributed data networks in a manner that is more high-performance and more scalable than prior art distributed file metadata approaches.

It is another object of the invention to provide a distributed data network that is adapted to such improved, distributed file metadata stores.

These and many other objects and advantages of the invention will become apparent from the ensuing description.

### SUMMARY OF THE INVENTION

The objects and advantages of the invention are secured by a computer-implemented method for constructing a distributed file system in a distributed data network in which file metadata related to data files is distributed. The method of invention calls for assigning a unique and non-reusable mode number to identify not only each data file that belongs to the data files but also a directory of that data file. A key-value store built up in rows is created for the distributed file metadata. Each of the rows has a composite row key and a row value pair, also referred to herein as key-value pair. The composite row key for each specific data file includes the mode number and a name of the data file.

A directory entry that describes that data file in a child directory is provided in the composite row key whenever the data file itself does not reside in the directory. When present in the directory, the data file is treated differently depending on whether it is below or above a maximum file size. For data files below the maximum file size a file offset is provided in the composite row key and the corresponding row value of the key-value pair is encoded with at least a portion of the data file or even the entire data file if it is sufficiently small. Data files that are above the maximum file size are stored in a large-scale storage subsystem of the distributed data network.

Preferably, data files below the maximum file size are broken up into blocks. The blocks have a certain set size to ensure that each block fits in the row value portion of the key-value pair that occupies a row of the key-value store. The data file thus broken up into blocks is then encoded in successive row values of the key-value store. The composite row key associated with each of the successive row values in the key-value store contains the mode number and an adjusted file offset, indicating blocks of the data file for easy access.

It is important that certain operations on any data file belonging to the data files whose metadata is distributed according to the invention be atomic. In other words, these operations should be indivisible and apply to only a single row (key-value pair) in the key-value store at a time. These operations typically include file creation, file deletion and file renaming. Atomicity can be enforced by requiring these operations to be lock-requiring operations. Such operations can only be performed while holding a leased row-level lock key. One useful type of row-level lock key in the context of the present invention is a mutual-exclusion type lock key.

In a preferred embodiment of the method, the distributed data network has one or more file storage clusters. These may be collocated with the servers of a single cluster, several clusters or they may be geographically distributed in some other manner. Any suitable file storage cluster has a large-scale storage subsystem, which may comprise a large number of hard drives or other physical storage devices. The subsystem can be implemented using Google's big-table, Hadoop, Amazon Dynamo or any other suitable large-scale storage subsystem operation.

The invention further extends to distributed data networks that support a distributed file system with distributed metadata related to the data files of interest. In such networks, a first mechanism assigns the unique and non-reusable mode numbers that identify each data file belonging to the data files and a directory of that data file. The key-value store holding the distributed file metadata is distributed among a set of servers. A second mechanism provides a directory entry in the composite row key for describing the data in a child directory when the particular data file does not reside in the directory. Local resources in at least one of the servers, are used for storing in the row value at least a portion of the data file if it is sufficiently small, i.e., if it is below the maximum file size. Data files exceeding this maximum file size are stored in the large-scale storage subsystem.

The distributed data network can support various topologies but is preferably deployed on servers in a single cluster. Use of servers belonging to different clusters is permissible, but message propagation time delays have to be taken into account in those embodiments. Also, the large-scale storage subsystem can be geographically distributed.

The details of the method and distributed data network of the invention, including the preferred embodiment, will now be described in detail in the below detailed description with reference to the attached drawing figures.

### BRIEF DESCRIPTION OF THE DRAWING FIGURES

FIG. 1 is a diagram illustrating the overall layout of a distributed data network with a number of servers sharing a distributed key-value store according to the invention;

FIG. 2 is a detailed diagram illustrating the key-value store distributed among the servers of the distributed data network of FIG. 1;

FIG. 3 is a still more detailed diagram illustrating the contents of two key-value pairs belonging to the key-value store shown in FIG. 2;

FIG. 4A-B are diagrams showing the break-up of a small data file (data file smaller than maximum file size) into blocks;

FIG. 5 is a diagram illustrating the application of the distributed key-value store over more than one cluster of servers.

### DETAILED DESCRIPTION

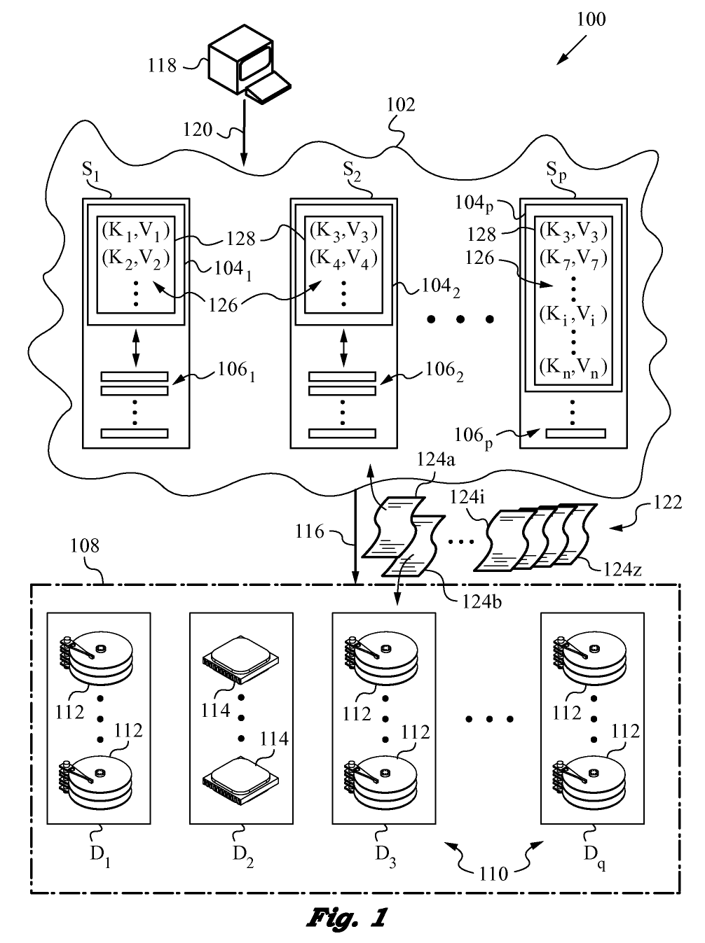

The present invention will be best understood by initially referring to the diagram of a distributed data network 100 as shown in FIG. 1. Network 100 utilizes a number of servers S₁, S₂, . . . , Sₚ, which may include hundreds or even thousands of servers. In the present embodiment, servers S₁, S₂, . . . , Sₚ belong to a single cluster 102. Each of servers S₁, S₂, . . . , Sₚ has corresponding processing resources 104₁, 104₂, . . . , 104ₚ, as well as local storage resources 106₁, 106₂, . . . , 106ₚ. Local storage resources 106₁, 106₂, . . . , 106ₚ may include rapid storage systems, such as solid state flash, and they are in communication with processing resources 104₁, 104₂, . . . , 104ₚ of their corresponding servers S₁, S₂, . . . , Sₚ. Of course, the exact provisioning of local storage resources 106₁, 106₂, . . . , 106ₚ may differ between servers S₁, S₂, . . . , Sₚ.

Distributed data network 100 has a file storage cluster 108. Storage cluster 108 may be collocated with servers S₁, S₂, . . . , Sₚ in the same physical cluster. Alternatively, storage cluster 108 may be geographically distributed across several clusters.

In any event, file storage cluster 108 has a large-scale storage subsystem 110, which includes groups D₁, D₂, D_{q} of hard drives 112 and other physical storage devices 114. The number of actual hard drives 112 and devices 114 is typically large in order to accommodate storage of data files occupying many petabytes of storage space. Additionally, a fast data connection 116 exists between servers S₁, S₂, . . . , Sₚ of cluster 102 and file storage cluster 108.

FIG. 1 also shows a user or client 118, connected to cluster 102 by a connection 120. Client 118 takes advantage of connection 120 to gain access to servers S₁, S₂, . . . , Sₚ of cluster 102 and to perform operations on data files residing on them or in large-scale storage subsystem 110. For example, client 118 may read data files of interest or write to them. Of course, it will be clear to those skilled in the art that cluster 102 supports access by very large numbers clients. Thus, client 118 should be considered here for illustrative purposes and to clarify the operation of network 100 and the invention.

The computer-implemented method according to the invention addresses the construction of a distributed file system 122 in distributed data network 100. Distributed file system 122 contains many individual data files 124a, 124b, . . . , 124z. Some of data files 124a, 124b, . . . , 124z are stored on local storage resources 106₁, 106₂, . . . 106ₚ, while some of data files 124a, 124b, . . . , 124z are stored in large-scale storage subsystem 110.

In accordance with the invention, the decision on where any particular data file 124i is stored depends on its size in relation to a maximum file size. Data file 124a being below the maximum file size is stored on one of servers S₁, S₂, . . . , Sₚ, thus taking advantage of storage resources 106₁, 106₂, . . . 106ₚ. In contrast, data file 124b exceeds maximum file size and is therefore stored in large-scale storage subsystem 100 of file storage cluster 108.

To understand the invention in more detail, it is necessary to examine how file metadata 126 related to data files 124a, 124b, . . . , 124z is distributed. In particular, file metadata 126 is distributed among servers S₁, S₂, . . . , Sₚ, rather than residing on a single server, e.g., a master, as in some prior art solutions. Furthermore, metadata 126 is used in building up a distributed key-value store 128. The rows of key-value store 128 contain distributed file metadata 126 in key-value pairs represented as (Kᵢ,Vᵢ) (where K=key and V=value). Note that any specific key-value pair may be stored several times, e.g., on two different servers, such as key-value pair (K₃,V₃) residing on servers S₂ and Sₚ. Also note, that although key-value pairs (Kᵢ,Vᵢ) are ordered (sorted) on each of servers S₁, S₂, . . . , Sₚ, in the diagram, that is not a necessary condition, as will be addressed below.

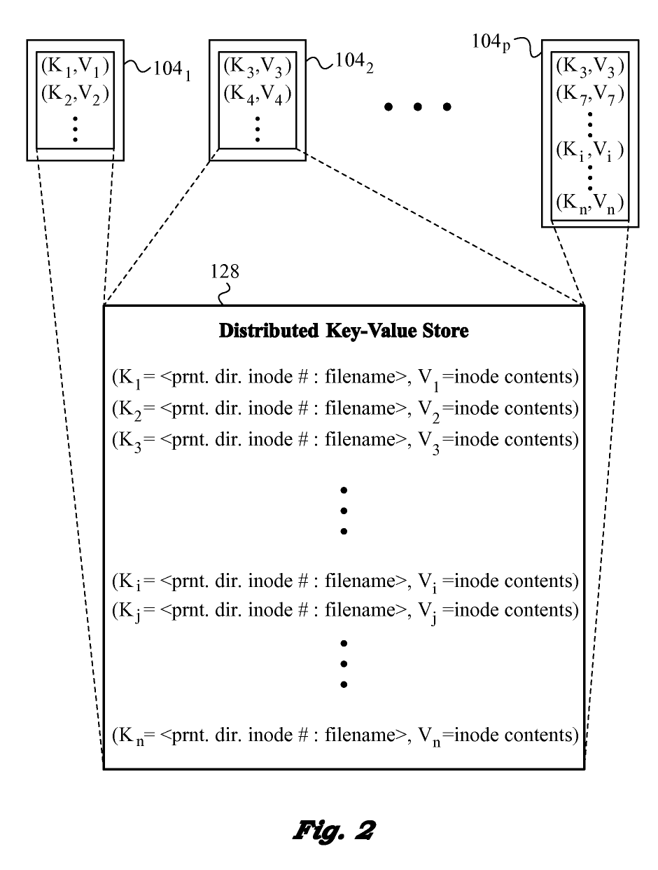

We now refer to the more detailed diagram of FIG. 2 illustrating key-value store 128 that is distributed among servers S₁, S₂, . . . , Sₚ of distributed data network 100 abstractly collected in one place. FIG. 2 also shows in more detail the contents of the rows (key-value pairs (Kᵢ,Vᵢ)) of distributed key-value store 128.

The method of invention calls for a unique and non-reusable mode number to identify not only each data file 124a, 124b, 124z of the distributed data file system 122, but also a directory of each data file 124a, 124b, . . . , 124z. Key-value store 128 created for distributed file metadata 126 contains these unique and non-reusable mode numbers. Preferably, the mode numbers are generated by a first mechanism that is a counter. Counters should preferably be on a highly-available data storage system that is synchronously replicated. Key-Value stores such as Big Table meet that requirement and can store the counter as the value of a pre-specified key as long as an atomic increment operation is supported on keys. The sequential nature of mode numbers ensures that they are unique and a very large upper bound on the value of these numbers ensures that in practical situations their number is unlimited.

As shown in FIG. 2, each of the rows of key-value store 128 has a composite row key Kᵢ and a row value Vᵢ, which together form the key-value pair (Kᵢ,Vᵢ). Each one of row keys Kᵢ is referred to as composite, because for each specific data file 124i it includes the mode number and a name of data file 124i, or Kᵢ=<prnt. dir. mode #:filename>. More explicitly, Kᵢ=<parent directory of file 124i, mode # of file 124i:filename of file 124i>. When data file 124i is not in the parent directory, then the filename is substituted by corresponding directory name. In other words, when file 124i does not reside in the parent directory, then instead of filename a directory entry is made in composite row key Kᵢ for describing data file 124i in a child directory where data file 124i is to be found. Each such directory entry is mapped to file 124i or directory metadata.

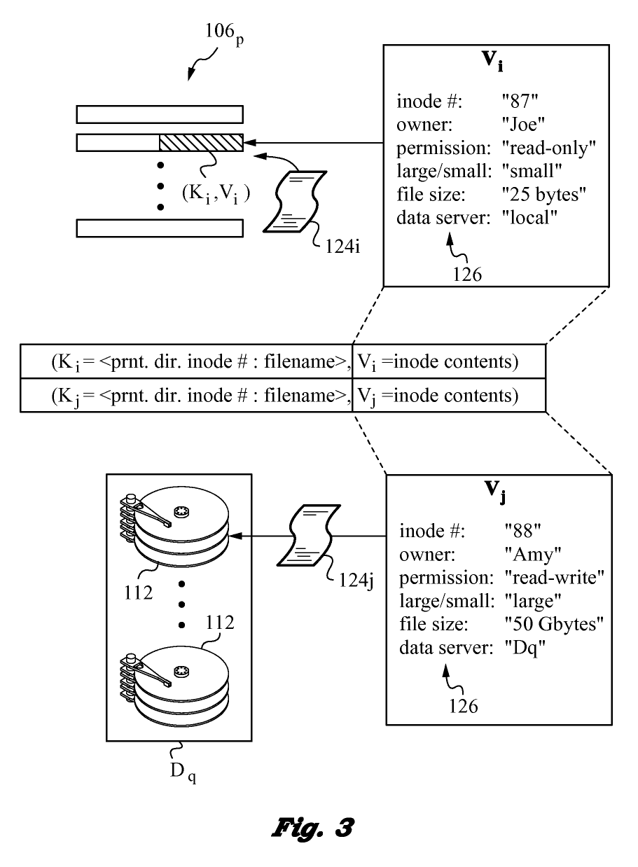

FIG. 3 is a still more detailed diagram illustrating the contents of key-value pairs (Kᵢ,Vᵢ), (Kᵢ, Vᵢ) belonging to distributed key-value store 128. In this diagram we see that file data itself is stored directly in key-value store 128 for data files up to the size that key-value store 128 permits. This high value is the maximum file size, typically on the order of many Mbytes.

Specifically, file 124i is small, as indicated by row value V, which contains metadata 126 related to file 124i. In the present case, metadata 126 includes mode number (mode #:“87”), identification of owner (owner:“Joe”), permissions (permission:“read-only”), file size classification (large/small:“small”), file size (file size:“25 bytes”) and storage location (data server:“local”). Thus, since file 124i is below maximum file size, it is stored locally on storage resources 106p directly in distributed key-value store 128 itself.

Meanwhile, file data that is too large to fit in key-value database is stored in one or more traditional fault-tolerant, distributed file systems in the large-scale storage subsystem 110. These distributed file systems do not need to support distributed metadata and can be embodied by file systems such as highly-available Network File Server (NFS) or the Google File System. Preferably, the implementation uses as large-scale file store one or more instances of the Hadoop Distributed Filesystem, e.g., as described by Cutting, D. E, (2006). Hadoop. Retrieved 2010, from Hadoop: http://hadoop.apache.org. Since the present invention supports an unbounded number of large-scale file stores (which are used solely for data storage, not metadata storage), the metadata scalability of any individual large-scale file store does not serve as an overall file system storage capacity bottleneck. In other words, the subsystem can be implemented using Google's big-table, Hadoop, Amazon Dynamo or any other suitable large-scale storage subsystem operation, yet without creating the typical bottlenecks.

In the example of FIG. 3, data file 124j is larger than maximum file size, as indicated by its metadata 126 in row value Vⱼ. Therefore, data file 124j is sent to large-scale storage subsystem 110, and more particularly to group D_{q} of hard drives 112 for storage.

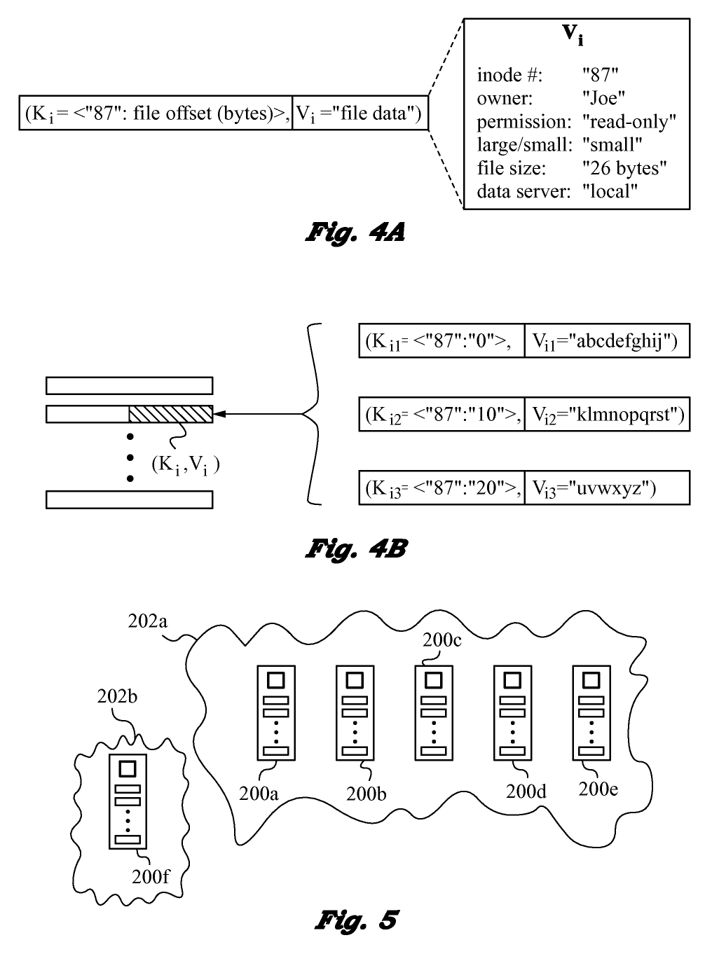

FIG. 4A-B are diagrams showing the break-up of a small data file, specifically data file 124i, into blocks. The breaking of data file 124i into fixed-size blocks enables the “file data” to be stored directly in the mode that is the content of row value Vᵢ. In the present example, the block size is 10 bytes. When storing a block of data file 124i directly in row value Vᵢ, the composite row key Kᵢ is supplemented with file offset information, which is specified in bytes.

Referring now to FIG. 4B, we see that for a file size of 26 bytes three blocks of 10 bytes are required. File data of data file 124i is encoded and stored into key-value store 128 one block per row in successive rows. The file data rows are identified by a unique per-file identification number and byte offset of the block within the file. File 124i takes up three rows in key-value store 128. These rows correspond to key-value pairs (Kᵢ₁,Vᵢ₁), (Kᵢ₂,Vᵢ₂) and (Kᵢ₃,vᵢ₃) Notice that all these rows have the same mode number (“87”), but the offset is adjusted in each row (0, 10 and 20 bytes respectively). Although in key-value store 128 these rows happen to be sorted, this is not a necessary condition. At the very least, the key-value stores need to be strongly consistent, persistent and support both locks and atomic operations on single keys. Multi-key operations are not required, and key sorting is not required (although key sorting does allow for performance improvements).

It is important that certain operations on any data file belonging to the data files whose metadata is distributed according to the invention be atomic, meaning that they are indivisible. In other words, these operations should apply to only a single row (key-value pair) in the key-value store at a time. These operations typically include file creation, file deletion and file renaming. Atomicity can be enforced by requiring these operations to be lock-requiring operations. Such operations can only be performed while holding a leased row-level lock key. One useful type of row-level lock key in the context of the present invention is a mutual-exclusion type lock key.

The invention further extends to distributed data networks that support a distributed file system with distributed metadata related to the data files of interest. In such networks, a first mechanism, which is embodied by a counter, assigns the unique and non-reusable mode numbers that identify each data file belonging to the data files and a directory of that data file. The key-value store holding the distributed file metadata is distributed among a set of servers. A second mechanism provides a directory entry in the composite row key for describing the data in a child directory when the particular data file does not reside in the directory. Local resources in at least one of the servers, are used for storing in the row value at least a portion of the data file if it is sufficiently small, i.e., if it is below the maximum file size, e.g., 256 Mbytes with current embodiments. This size can increase in the future. Data files exceeding this maximum file size are stored in the large-scale storage subsystem.

A distributed data network according to the invention can support various topologies but is preferably deployed on servers in a single cluster. FIG. 5 illustrates the use of servers 200a-f belonging to different clusters 202a-b. Again, although this is permissible, the message propagation time delays have to be taken into account in these situations. A person skilled in the art will be familiar with the requisite techniques. Also, the large-scale storage subsystem can be geographically distributed. Once again, propagation delays in those situations have to be accounted for.

The design of distributed data network allows for performance of all standard filesystem operations, such as file creation, deletion, and renaming while storing all metadata in a distributed key-value store. All operations are atomic (or appear to be atomic), without requiring the distributed key-value store to support any operations beyond single-row atomic operations and locks. Furthermore, only certain operations, such as renaming and rename failure recovery require the client to obtain a row lock. All other operations are performed on the server and do not require the client to acquire explicit row locks.

Existing distributed key-values do not support unlimited-size rows, and are not intended for storing large (multi-terabyte files). Thus, placing all file data directly into a key-value store is not required in our design for all file sizes. Many existing distributed filesystems can accommodate a reasonable number (up to millions) of large files given sufficient slaves for storing raw data. However, these storage systems have difficulty coping with billions of files. Most filesystems are dominated by small files, usually less than a few megabytes. To support both enormous files and numerous (billions) files, our system takes the hybrid approach presented by the instant invention.

Small files, where small is a user-defined constant based on the maximum row size of the key-value store, are stored directly in the key-value store in one or more blocks. Each row stores a single block. In our implementation, we use an eight kilobyte block size and a maximum file size of one megabyte as our cutoff value for storing a file directly in the key-value store. Large files, such as movies or multi-terabyte datasets, are stored directly in one or more existing large-scale storage subsystem as the Google File System or a SAN. Our implementation uses one or more Hadoop Distributed Filesystem clusters as a large-scale file repository. The only requirement for our filesystem is that the large-scale repository be distributed, fault tolerant, and capable of storing large files. It is assumed that the large-scale file repositories do not have distributed metadata, which is why multiple large-scale storage clusters are supported. This is not a bottleneck because no metadata is stored in large-scale storage clusters, and our filesystem supports an unbounded number of large-scale storage clusters. Large files include a URL describing the file's location on the large-scale storage system in the file mode.

Files stored in the key-value store are accessed using a composite key row key consisting of the file mode number and the block offset. The resulting row's value will be the block of raw file data located at the specified block offset. The last block of a file may be smaller than the block size if the overall file size is not a multiple of the block size, e.g., as in the example described in FIG. 4B.

The great advantage of the methods and networks of invention is that they easily integrate with existing structures and mechanisms. Below, we detail the particulars of how to integrate the advantageous aspects of the invention with such existing systems.

### Requirements

The distributed key value store must provide a few essential properties. Single-row updates must be atomic. Furthermore, single row compare-and-update and compare-and-delete operations must be supported, and must also be atomic. Finally, leased single-row mutex (mutual exclusion) locks must be supported with a fixed lease timeout (60 seconds in our implementation). While a row lock is held, no operations can be performed on the row by other clients without the row lock until the row lock lease expires or the row is unlocked. Any operation, including delete, read, update, and atomic compare-and-update/delete may be performed with a row lock. If the lock has expired, the operation fails and returns an error, even if the row is currently unlocked. Distributed key-value stores such as HBase as described, e.g., by Michael Stack, et al., (2007), HBase. retrieved from HBase: http://hadoop.apache.org/hbase/ meet these requirements.

We now describe how distributed key-value store 128 supports all standard filesystem operations:

### Bootstrapping the Root Directory

The root directory is assigned a fixed mode number of 0, and has a hardcoded mode. While the root mode is not directly stored in the key-value store, the directory entries describing any directories or files contained within the root directory are contained in the key-value store.

### Pathname Resolution

To look up a file, the absolute file path is broken into a list of path elements. Each element is a directory, except the last element, which may be a directory or file (if the user is resolving a file or directory path, respectively). To resolve a path with N path elements, including the root directory, we fetch N−1 rows from the distributed key value store.

Initially, the root directory mode is fetched as described in the Bootstrapping section. Then we must successfully fetch each of the remaining N−1 path elements from the key-value. When fetching an element, we know the mode for its parent directory (as that was the element mostly recently fetched), as well as the name of element. We form a composite row key consisting of the mode number of the parent directory and the element name. We then look up the resulting row in the key-value store. The value of that row is the mode for the path element, containing the mode number and all other metadata. If the row value is empty, then the path element does not exist and an error is returned.

If the path element is marked ‘pending’ as described in the ‘Rename Inode Repair’ section, rename repair must be performed as described in the aforementioned section before the mode can be returned by a lookup operation.

### Create File or Directory Inode

To create a file or directory, we first look up the parent directory, as described in the Lookup section. We then create a new mode describing the file or directory, which requires generating a new unique mode number for the file or directory, as well as recording all other pertinent filesystem metadata, such as storage location, owner, creation time, etc.

A row key is created by taking the mode number of the parent directory and the name of the file or directory to be created. The value to be inserted is the newly generated mode. To ensure that file/directory creation does not overwrite an existing file or directory, we insert the row key/value by instructing the distributed key-value store to perform an atomic compare-and-update. An atomic compare-and-update overwrites the row identified by the aforementioned row key with our new mode value only if the current value of the row is equal to the comparison value. By setting the comparison value to null (or empty), we ensure that the row is only updated if the previous value was non-existent, so that file and directory creation do not overwrite existing files or directories. Otherwise an error occurs and the file creation may be re-tried.

### Delete File or Directory Inode

To delete a file or directory, the parent directory mode is first looked up as describing in the Lookup section. A composite row key is then formed using the parent directory mode number and the name of the file or directory to be deleted. Only empty directories may be deleted (users must first delete the contents of an empty directory before attempting to delete the directory itself). A composite row key is created using the parent directory mode and the name of file or directory to be removed. The row is then read from the distributed key-value store to ensure that the deletion operation is allowed by the system. An atomic compare-and-delete is then performed using the same row key. The comparison value is set to the value of the mode read in the previous operation. This ensures that no time-of-check time-of-use security vulnerabilities are present in the system design while avoiding excessive client-side row locking.

### Update File or Directory Inode

File or directory modes may be updated to change security permissions, update the last modified access time, or otherwise change file or directory metadata. Updates are not permitted to change the mode name or mode number.

To update a file or directory, the parent directory is looked up as described in the Lookup section. Then the file mode is read from the key-value store using a composite row key consisting of the parent directory mode number and the file/directory name. This is referred to as the ‘old’ value of the inode. After performing any required security or integrity checks, a copy of the inode, the ‘new’ value, is updated in memory with the operation requested by the user, such as updating the last modified time of the inode. The new mode is then stored back to the key-value store using an atomic compare and swap, where the comparison value is the old value of the inode. This ensures that all updates occur in an atomic and serializable order. If the compare and swap fails, the operation can be re-tried.

### Rename File or Directory Inode

Renaming is the most complex operation in modern filesystems because it is the only operation that modifies multiple directories in a single atomic action. Renaming both deletes a file from the source directory and creates a file in the destination directory. The complexity of renaming is even greater in a distributed metadata filesystem because different servers may be hosting the rename source and destination parent directories—and one or both of those servers could experience machine failure, network timeouts, and so forth during the rename operation. Despite this, the atomicity property of renaming must be maintained from the perspective of all clients.

To rename a file or directory, the rename source parent directory and rename destination parent directory are both resolved as described in the Lookup section. Both directories must exist. The rename source and destination modes are then read by using composite row keys formed from the rename source parent directory mode number and rename source name, and the rename destination parent director mode number and rename destination name, respectively.

The rename source mode should exist, and the rename destination mode must not exist (as rename is not allowed to overwrite files). At this point, a sequence of actions must be taken to atomically insert the source mode into the destination parent directory, and delete the source mode from the source parent directory.

We perform the core rename operation in a four step process using mutual exclusion row locks. Any suffix of these steps may fail due to lock lease expiration or machine failure. Partially completed rename operations, whether due to machine failure, software error, or otherwise are completely addressed in the ‘Rename Inode Failure Recovery’ section to preserve atomicity. Recovery occurs as part of mode lookup (see the ‘Lookup’ section) and is transparent to clients.

Row locks are obtained from the key-value store on the rename source and destination rows (with row keys taken from the source/destination parent directory mode numbers and the source/destination names). It is crucial to lock these two rows be locked in a well-specified total order. Compare the source and destination row keys, which must be different values as you cannot rename a file to the same location. Lock the lesser row first, then the greater row. This prevents a deadly embrace deadlock that could occur if multiple rename operations were being executed simultaneously.

With the row locks held, the rename operation occurs in 4 stages:

A copy of the source mode is made, and the copy is updated with a flag indicating that the mode is ‘pending rename source’. The row key of the rename destination is recorded in the new source inode. An atomic compare-and-update is then performed on the source row with the source row lock held. The update value is the new source inode. The comparison value is the value of the original ('old') source inode. If the compare-and-update fails (due to an intervening write to the source mode before the row lock was acquired), the rename halts and returns an error.

A second copy of the source mode is made and the copy is updated with a flag indicating that the mode is ‘pending rename destination’. This pending destination mode is then updated to change its name to the rename destination name. The mode number remains the same. The row key of the rename source is then recorded in the new destination mode. An atomic compare-and-update is performed on the destination row with the destination row lock held. The update value is the new pending rename destination mode. The comparison value is an empty or null value, as the rename destination should not already exist. If the compare-and-update fails, the rename halts and returns an error. The compare-and-update is necessary because the rename destination may have been created in between prior checks and the acquisition of the destination row lock.

The row identified by the source row key is deleted from the key value store with the source row key lock held. No atomic compare-and-delete is necessary because the source row lock is still held, and thus no intervening operations have been performed on the source mode row.

A copy of the ‘Pending Destination Inode’ is created. This copy, referred to as the ‘final destination inode’ is updated to clear its ‘Pending Rename Destination’ flag, and to remove the source row key reference. This marks the completion of the rename operation. The final destination mode is written to the key-value store by updating the row identified by the destination row key with the destination row lock held. The update value is the final destination mode. No atomic compare-and-swap is necessary because the destination row lock has been held throughout steps 1-4, and thus no intervening operation could have changed the destination mode.

Finally, the source and destination row locks are unlocked (in any order).

### Rename Inode Failure Recovery

A rename operation is the only single filesystem operation that modifies multiple rows. As a consequence, a rename operation may fail and leave the modes in intermediate ‘pending’ states. Let any mode marked as ‘Rename Source Pending’ or ‘Rename Destination Pending’ be described as ‘pending’. To transparently and atomically recover from rename failures, the filesystem must ensure that all pending modes are resolved (either by fully redoing or fully undoing the rename operation) before they can be read. All mode reads occur during lookup, as described in the ‘Lookup’ section.

All mode mutations are performed via a compare-and-update/delete, or in the case of rename, begin with a compare-and-update and require all further mutations to be performed with the appropriate row lock held. No lookup operation or mode read can return an mode in the ‘pending’ state. Thus, mode modifications cannot operate on an mode that was marked ‘pending’, because the compare-and-update or compare-and-delete will fail.

If an mode is accessed and is marked ‘pending’, mode lookup (as described in ‘Lookup’) will invoke rename recovery.

First, row locks are obtained on the rename source and destination mode as described in the ‘Rename Inode’ section. We can determine the row keys for both rename source and destination rows, as source pending modes include the row key for the destination row, and destination pending modes include the row key for source row.

If the mode is marked ‘source pending’, recovery occurs in the following sequence of operations:

The source mode is read from the key-value store using the source row key with the source row lock held. If the mode differs from the source mode previously read, then a concurrent modification has returned and recovery exits with an error (and a retry may be initiated).

The destination mode is read from the key-value store using the destination row key with the destination row lock held.

If the destination mode is not marked ‘pending’ or it is marked ‘pending’ but the source row key for the destination mode is not equal to the current source row key, then the rename must have failed after step 1 as described in ‘Renaming Inodes’. Otherwise, the destination mode would have been marked ‘pending rename destination’ with source row key set to the current source mode's row key. Since this is not the case, and we know that no further mode modifications on a ‘pending’ mode can occur until its pending status is resolved, we know that the destination was never marked as ‘pending rename’ with the current source mode. Consequently, the rename must be undone and the source mode pending status removed. To accomplish this, the source pending mode is modified by clearing the source pending mode flag. We then persist this change by performing an update on the key-value store using the row identified by the source row key and the value set to the new source mode, with the source row lock held.

Otherwise the destination mode is marked ‘pending’ with source row key equal to the current source mode row key. In this case, the rename must be ‘redone’ so that it is completed. The steps taken are exactly the same as those in the original rename operation. This is what allows recovery to be repeated more than once with the same result—in other words, recovery is idempotent. Specifically we repeat steps (3) and (4) as described in ‘Renaming Inodes’ using the source and destination modes identified in the recovery procedure.

Otherwise, the ‘pending’ mode must be marked ‘destination pending’.

Recovery is similar to ‘source pending’-marked inodes, and is performed as follows:

The destination mode is read from the key-value store using the destination row key with the destination row lock held.

If the mode differs from the destination mode previously read, then a concurrent modification has returned and recovery exits with an error (and a retry may be initiated).

The source mode is read from the key-value store with the source row key held.

If the source mode does not exist or is marked ‘pending’ but has its destination row key set to a value not equal to the current destination mode's row key, then the rename succeeded and the source mode was deleted and replaced by a new value. Otherwise, a mutation would have occurred to modify the source mode, but this is impossible because all read mode operations must resolve any ‘pending’ modes before returning, and all mode mutations are performed via compare-and-swap or require mutual exclusion row locks. As the source mode must have been deleted by the rename, the destination mode has its ‘pending rename destination’ flag cleared. The new mode is then persisted to the key value stored by updating the row identified by the destination row key with the new destination mode value, all with the destination row lock held.

Otherwise, the source mode was marked ‘rename source pending’ and has its destination row key set to the current destination's row key. In this case, the rename must be re-done so that it can be committed.

To perform this, we repeat steps (3)-(4) as described in ‘Renaming Inodes’ exactly.

Finally, in both the source and destination ‘pending’ mode cases, the source and destination row locks are unlocked (in either order) and the newly repaired mode is returned. At the end of a source mode pending recovery, the source mode is either null or is not marked ‘pending’. Similarly, at the end of a destination mode pending recovery, the mode is not marked ‘pending’. Thus, as long as pending rename recovery is performed before an mode can be returned, all modes read by other filesystem routines are guaranteed to be clean, and not marked ‘pending’, preventing any other operations from reading (and thus modifying) ‘pending’ modes.

### Write File Data

When a user writes data to a file, that data is buffered. If the total written data exceeds the maximum amount allowed for a key-value store, a new file on a large-file storage subsystem is created, all previously written data is flushed to that file, and all further writes for the file are written directly to the large file storage subsystem.

Otherwise, if the total data written is less than the maximum amount for the key-value store when the file is closed, then the written data is broken into equal-sized blocks, except that the last block may be less than the block size if the total data length is not a multiple of the block size. If the file data consists of B blocks, then B update operations are performed on the key-value store. To write the Ith block, a composite row key is created from the file mode number and the byte offset of the block, which is I*BlockSize. The value of the row is the raw data bytes in the range (I*BlockSize . . . (I+1)*BlockSize−1) inclusive.

### Read File Data

To read file data in a specified byte range, the file mode is examined to determine if the file is stored in the key value store or the large-file storage system. If the latter is true, then the read operation is passed directly to the large-file storage system.

Otherwise, the file read operation must be passed to the key-value store. The lower (upper) bounds of the read operation are rounded down (up) to the nearest multiple of the block size. Let the number of blocks in this range be B. B read operations are then issued to the key-value store using a composite row key consisting of the file mode and the (blocksize-aligned) byte offset of the requested block. The B blocks are then combined, and any bytes outside of the requested read operation's lower and upper bounds are discarded. The resulting byte array is returned to client as the value of the read operation.

In view of the above teaching, a person skilled in the art will recognize that the method and distributed data network of invention can be embodied in many different ways in addition to those described without departing from the spirit of the invention. Therefore, the scope of the invention should be judged in view of the appended claims and their legal equivalents.

I claim:

1. A computer-implemented method for constructing a distributed file system in a distributed data network with distributed file metadata related to data files, said method comprising the steps of:
a) assigning a unique and non-reusable mode number to identify each data file belonging to said data files and a directory of said data file;
b) creating a key-value store for said distributed file metadata, said key-value store having rows, where each of said rows comprises a composite row key and a row value pair, said composite row key comprising for each said data file said mode number and a name of said data file;
c) providing a directory entry in said composite row key for describing said data file in a child directory when said data file does not reside in said directory;
d) providing a file offset in said composite row key and encoding in said row value at least a portion of said data file when said data file is below a maximum file size; and
e) storing said data file in a large-scale storage subsystem of said distributed data network when said data file exceeds said maximum file size.

2. The method of claim 1, wherein said data file below said maximum file size is broken up into blocks such that each of said blocks fits in said row value of said key-value store, and encoding said data file in successive row values of said key-value store.

3. The method of claim 2, wherein each said composite row key associated with each of said successive row values in said key-value store contains said mode number and an adjusted file offset indicating blocks of said data file.

4. The method of claim 2, wherein said blocks have a set and predetermined size.

5. The method of claim 1, wherein predetermined operations on said data file are atomic by applying to only a single one of said rows of said key-value store.

6. The method of claim 5, wherein said predetermined operations include the group consisting of file creation, file deletion, file renaming.

7. The method of claim 5, wherein said predetermined operations on said data file are lock-requiring operations performed while holding a leased row-level lock key.

8. The method of claim 7, wherein said leased row-level lock key is a mutual-exclusion type lock key.

9. The method of claim 1, wherein said distributed data network comprises at least one file storage cluster that comprises said large-scale storage subsystem.

10. The method of claim 9, wherein said large-scale storage subsystem is selected from the group consisting of big-table, Hadoop, Amazon Dynamo.

11. A distributed data network supporting a distributed file system with distributed file metadata related to data files, said distributed data network comprising:
a) a first mechanism for assigning a unique and non-reusable mode number to identify each data file belonging to said data files and a directory of said data file;
b) a set of servers having distributed among them a key-value store for said distributed file metadata, said key-value store having rows, where each of said rows comprises a composite row key and a row value pair, said composite row key comprising for each said data file said mode number and a name of said data file;
c) a second mechanism for providing a directory entry in said composite row key for describing said data file in a child directory when said data file does not reside in said directory;
d) local resources in at least one of said servers, for storing in said row value at least a portion of said data file when said data file is below a maximum file size; and
e) a large-scale storage subsystem for storing said data file when said data file exceeds said maximum file size.

12. The distributed data network of claim 11, wherein a file offset is provided in said composite row key when said data file is below said maximum file size.

13. The distributed data network of claim 11, wherein said set of servers belongs to a single cluster.

14. The distributed data network of claim 11, wherein said set of servers is distributed between different clusters.

15. The distributed data network of claim 11, wherein said large-scale storage subsystem is geographically distributed.
